(19) United States
(12) Patent Application Publication
(10) Pub. No.: US 2005/0265120 A1
(43) Pub. Date: Dec. 1, 2005

(54) Ultrasonic dispersion device

(75) Inventor: Koji Naoe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/139,486

(22) Filed: May 31, 2005

(30) Foreign Application Priority Data
May 28, 2004 (JP) 2004-159328

(51) Int. Cl. B01F 11/02

(52) U.S. Cl. 366/114

(57) ABSTRACT

An ultrasonic dispersion device of a batch type comprising an ultrasonic oscillator and a liquid vessel, wherein an oscillation frequency of the ultrasonic oscillator is 20 kHz or less, the ultrasonic oscillator is secured to the liquid vessel, and the ultrasonic oscillator is able to come into contact with a treated liquid.

### BACKGROUND OF THE INVENTION

1. Field of the Invention

The present invention relates to an ultrasonic dispersion device, and more particularly to an ultrasonic dispersion device that disperses powder having an average primary particle size in nanometer to submicron scales into a solvent or a solution, is able to prepare a liquid with high dispersion stability containing no sediment, and allows for mass production.

2. Related Art

A technique of dispersing fine grained powder having an average primary particle size in nanometer to submicron scales has become increasingly important in production of functional films, specifically, production of photographic materials or magnetic recording media, or production of optical films such as optical compensation films, anti-reflective films, or anti-glare films. In particular, the technique of dispersing fine grained powder is important in terms of forming a more uniform film without defects, or liquid handling (liquid viscosity reduction) in high dispersion.

Generally known methods of dispersing a solution containing fine grained powder include the following methods:
1) a bead mill dispersion method using beads having small diameters;
2) a jet mill dispersion method of causing collision of liquids at high pressure;
3) a method of crushing agglomerated particles by a shearing force caused by high speed rotation in a rotor/stator gap of a homomixer or the like; and
4) a method of crushing agglomerated particles by a shearing force caused by a roll mill or various types of mixers.

The bead mill dispersion method in the item 1) can uniformly disperse a solution containing fine grained powder by controlling a diameter of a bead, a filling factor of beads into a device, a residence time of a treated liquid in the device, a particle volume ratio of the treated liquid, and an absorption state of a bonding agent or the like to a particle surface. Thus, this method is an excellent dispersion method. However, particle crushing proceeds during liquid treatment to cause reagglomeration of particles and increase liquid viscosity, thereby reducing productivity.

For this reason, by the bead mill dispersion method only, it is difficult to disperse powder having an average primary particle size in nanometer to submicron scales into a solvent or a solution, and to construct a dispersion system that provides high volume production.

The jet mill dispersion method in the item 2) includes a mechanism of causing collision of liquids at high pressure, which increases the size of a device. It is also difficult to construct a dispersion system as a device for volume production in terms of cleaning or maintenance.

The method using the homomixer in the item 3) causes particle crushing by high speed rotation in the rotor/stator gap, but cannot prepare a dispersion liquid without sediment when fine grained powder having an average primary particle size in nanometer to submicron scales is placed into a solvent and treated. This may be because the particle crushing locally occurs, crushing energy is low, and a swirling flow provides insufficient circulation of agglomerated particles, thereby preventing a dispersion liquid without sediment from being prepared.

The method of using the roll mill or various types of mixers in the item 4) has a great effect of crushing fine grained powder in a primary particle level and absorbing resin components such as a bonding agent by a high shearing force, but nonuniform mixed portions (agglomerated particles) are compressed by a strong force. This prevents crushing of the agglomerated particles even if bead mill dispersion processing is also used, or increases time for the bead mill dispersion processing, thereby reducing productivity.

The problems described in the items 1) to 4) become more pronounced as the particle size of the fine grained powder becomes smaller. Generally, for the fine grained powder, a surface area of the powder increases as the particle becomes finer, which increases the size of secondary agglomerated particles. Reducing the size of the secondary agglomerated particles is difficult for powder producers in terms of handling of the powder.

Other than the items 1) to 4), an ultrasonic dispersion method is known as a method of dispersing a liquid containing fine grained powder. Various types of ultrasonic dispersion devices for this method are commercially available. As such a device, an ultrasonic dispersion device of a circulation type (an ultrasonic homogenizer) that operates at a frequency of 20 or less kHz is generally used in terms of uniform dispersion or a measure to high temperature (keep cooled) of a treated liquid.

On the other hand, an ultrasonic dispersion device of a batch type is applied only to use for preparing a small amount of liquid such as for pretreatment of measurement of an experiment level or a particle size distribution because of a problem of liquid circulation to an ultrasound application portion (ultrasound is not uniformly applied), and is difficult to be applied as a production device that provides high volume production.

In order to treat a treated liquid with the circulation type dispersion device (the bead mill dispersion device, the ultrasonic homogenizer, or the like), liquid treatment is required that causes no sediment in the treated liquid containing fine grained powder, and causes no reagglomeration or reduction in dispersability in a storage time before circulation type dispersion processing.

In order to solve the problems, the inventor has proposed a liquid preparation technique using ultrasonic dispersion, and a predetermined advantage has been confirmed (Japanese Patent Application Laid Open Nos. 2004-30762 and 2004-30763). Specifically, the technique is a processing method of a magnetic coating containing a liquid A including ferromagnetic powder and a solvent, and a solution B of a bonding agent, the liquid A and the solution B being mixed by applying ultrasound and then dispersion processing being performed. Agglomerated particles of the ferromagnetic powder can be crushed and agglomeration of the ferromagnetic powder can be prevented, and thus a liquid containing ferromagnetic powder with uniform absorption of the bonding agent can be obtained and a magnetic coating suitable for a high density coating type magnetic recording medium with low noise can be obtained.

### SUMMARY OF THE INVENTION

However, with the method disclosed in Japanese Patent Application Laid Open Nos. 2004-30762 and 2004-30763, treatment of a large amount of liquid is difficult, and volume production cannot be sufficiently addressed.

Ultrasonic dispersion devices commercially available (for example, an ultrasonic dispersion device produced by Nippon Seiki Seisakusho, model No. USDS-1, oscillation frequency: 20 kHz) includes a stirrer and has an ultrasonic oscillator in an upper lid of a tank. The tank has a shallow configuration with an inner diameter of the tank being larger than a depth of the tank, and treats 3 L of liquid, which is not suitable for volume production.

Thus, a liquid preparation device has been desired that disperses powder having an average primary particle size in nanometer to submicron scales into a solvent or a solution, is able to prepare a liquid with high dispersion stability containing no sediment, and provides high volume production, but there has been no liquid preparation device of such a type.

The present invention has an object to provide a liquid preparation device that solves the problems of the conventional technique and disperses powder having an average primary particle size in nanometer to submicron scales into a solvent or a solution, is able to prepare a liquid with high dispersion stability containing no sediment, and provides high volume production.

In order to achieve the above described object, the present invention provides an ultrasonic dispersion device of a batch type including: an ultrasonic oscillator; and a liquid vessel, wherein an oscillation frequency of the ultrasonic oscillator is 20 kHz or less, the ultrasonic oscillator is secured to the liquid-vessel, and the ultrasonic oscillator is able to come into contact with a treated liquid.

According to the present invention, the oscillation frequency of the ultrasonic oscillator is 20 kHz or less, and the ultrasonic oscillator is able to come into contact with the treated liquid. Thus, the device has a high crushing capability of powder having an average primary particle size in nanometer to submicron scales, is able to prepare a liquid with high dispersion stability containing no sediment, and provides high volume production.

Specifically, the oscillation frequency of the ultrasonic oscillator is 20 kHz or less, and thus the device has the high crushing capability of powder having the average primary particle size in nanometer to submicron scales. Also, unlike a conventional ultrasonic cleaner of a batch type or the like, the ultrasonic oscillator is able to directly come into contact with the treated liquid, thereby providing higher dispersion performance than ever before.

In the present invention, the ultrasonic oscillator is preferably secured to the liquid vessel by a one-touch joint. The ultrasonic oscillator is thus secured by the one-touch joint to facilitate changing an arrangement of the ultrasonic oscillator, and allow changes of the amount of treated liquid or the like to be addressed with flexibility, which is desirable as a production device. Various types of known joints such as a ferrule joint may be used as a one-touch joint.

In the present invention, the ultrasonic dispersion device preferably includes a stirring device. The ultrasonic oscillator is used together with the stirring device to provide high dispersion performance. Various types of known stirring devices such as a stirrer may be used.

As described above, according to the present invention, the device has a high crushing capability of powder having an average primary particle size in nanometer to submicron scales, is able to prepare a liquid with high dispersion stability containing no sediment, and provides high volume production.

### BRIEF DESCRIPTION OF THE DRAWING

FIG. 1 is a sectional view of an ultrasonic dispersion device according to the present invention.

### DETAILED DESCRIPTION OF THE PREFERRED EMBODIMENTS

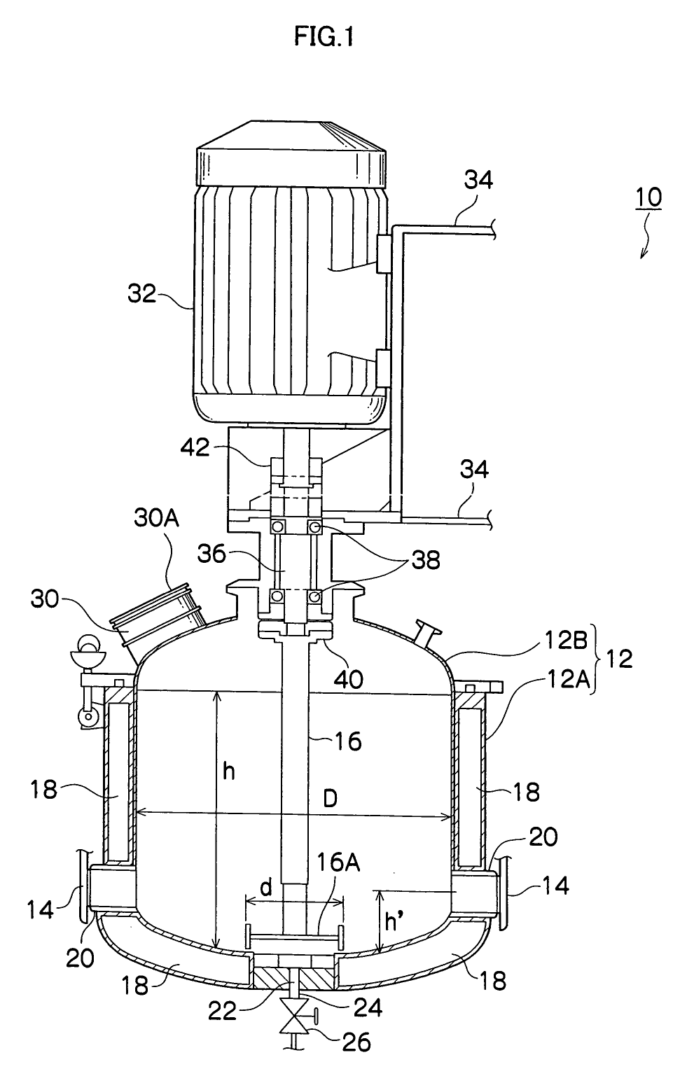

Now, a preferable embodiment of an ultrasonic dispersion device according to the present invention will be described in detail with reference to the accompanying drawings. FIG. 1 is a sectional view of an ultrasonic dispersion device 10.

As shown in FIG. 1, the ultrasonic dispersion device 10 of a batch type includes a liquid vessel 12, ultrasonic oscillators 14 and 14, and a stirrer 16, or the like. The liquid vessel 12 is constituted by a liquid vessel body 12A and a lid 12B. Various types of known members may be used as components, but members made of materials that causes no contamination and no corrosion are preferably used in terms of the nature of a dispersed liquid to be treated.

The liquid vessel body 12A preferably has an inner diameter D of 500 mm or less, and more preferably 300 mm or less. When the inner diameter D is 300 mm and a height h of the vessel is 200 mm, the capacity of the liquid vessel body 12A is about 15 L.

A side surface and a bottom surface of the liquid vessel body 12A have double structures, and cooling jackets 18, 18 . . . are formed so that cooling water can be circulated in the cooling jackets 18, 18 . . . .

The ultrasonic oscillators 14 are secured in two places of the side surface of the liquid vessel body 12A through the liquid vessel body 12A. The ultrasonic oscillator 14 has an output of 600 W, an oscillation frequency of 20 kHz, and an amplitude of 30 μm. An ultrasound application area by each ultrasonic oscillator 14 is 10.18 cm².

The ultrasonic oscillator 14 is vertically placed so that a center thereof is positioned at a height h′ of 50 mm from an inner bottom surface of the liquid vessel body 12A. The ultrasonic oscillator 14 is placed at about the height h′ to allow ultrasound to be effectively applied to the treated liquid.

Two ultrasonic oscillators 14 are circumferentially spaced 180° apart. Specifically, when a plurality of ultrasonic oscillators 14 are provided, the ultrasonic oscillators 14 are preferably placed equidistant from a stirring shaft of the stirrer 16. For example, when two ultrasonic oscillators 14 are provided, the ultrasonic oscillators 14 are preferably circumferentially spaced 180° apart as shown in FIG. 1, and when four ultrasonic oscillators 14 are provided, the ultrasonic oscillators 14 are preferably circumferentially spaced 90° apart.

The ultrasonic oscillators 14 are secured to the liquid vessel body 12A by ferrule joints 20 and 20. A one-touch joint such as the ferrule joint 20 is used to facilitate attachment and detachment of the ultrasonic oscillator 14. A one-touch joint other than the ferrule joint 20 may be used.

A tip surface of the ultrasonic oscillator 14 is secured so as to be flush with an inner wall of the liquid vessel body 12A. A ceramic coated layer having a thickness of 4 mm and consisting predominantly of zirconia (ZrO₂) is formed on the tip surface (an application surface) of the ultrasonic oscillator 14. Such a coated layer is formed to prevent erosion of the tip surface (the application surface) caused by ultrasonic oscillation (cavitation).

A through hole 22 to be a liquid drain hole is provided in the bottom surface of the liquid vessel body 12A. A pipe 24 is then connected to the through hole 22, and a stop valve 26 is connected to the pipe 24. Thus, the stop valve 26 is operated to easily drain the treated liquid.

As shown in FIG. 1, in the liquid vessel 12, the stirrer 16 is inserted into the liquid vessel body 12A from above the liquid vessel body 12A through the lid 12B so as to stir the treated liquid.

A stirring blade 16A is secured to a lower end of the stirrer 16. The stirring blade 16A is vertically placed so that a center thereof is positioned at a height of 15 mm from an inner bottom surface of a center of the liquid vessel body 12A. The stirring blade 16A is of a dissolver type, and has an outer diameter d of 80 mm.

A ratio d/D between the outer diameter d of the stirring blade 16A and the inner diameter D of the liquid vessel body 12A is preferably in a range of 0.1 to 0.6. It is confirmed that other ratios d/D cause reduction in stirring efficiency.

The stirring blade 16A is preferably of a dissolver type or a paddle type. The stirring blade 16A is most preferably of such a shape as to stir while scraping the inner bottom surface of the liquid vessel body 12A like a scraper.

In the ultrasonic dispersion device 10 according to the present invention, it is important that agglomerated particles in the treated liquid in the inner bottom portion of the liquid vessel body 12A are conveyed near the ultrasonic oscillators 14 (ultrasound application portions) in a lower portion of the side surface of the liquid vessel body 12A by a stirring flow by the stirrer 16, and liquid pressure on the inner side surface of the liquid vessel body 12A caused by stirring by the stirrer 16 is reduced.

Thus, in order to increase particle crushing efficiency in the application of the ultrasound, the shape and the outer diameter of the stirring blade 16A is preferably set according to the capacity (the inner diameter and the depth) of the liquid vessel body 12A. This prevents sediment from occurring for a few days even in the treated liquid using no bonding agent.

Next, other components of the ultrasonic dispersion device 10 will be described.

A raw material introduction port 30 is provided in the lid 12B, and a lid 30A is opened to introduce raw materials. A motor 32 is provided above the liquid vessel 12 so as to rotationally drive the stirrer 16. The motor 32 is secured to an unshown frame via stays 34 and 34.

An intermediate shaft 36 that connects the motor 32 and the stirrer 16 is supported on the lid 12B rotatably by bearings 38 and 38. The stirrer 16 and the intermediate shaft 36 are connected by a flange joint 40, and a shaft of the motor 32 and the intermediate shaft 36 are connected by a coupling 42. The motor 32 is controlled to vary the RPM of the stirrer 16, for example, in a range of 0 to 1700 RPM.

The RPM of the stirrer 16 is preferably varied according to the shape and the outer diameter d of the stirring blade 16A and the inner diameter D of the liquid vessel body 12A.

The above described configuration is an example of the ultrasonic dispersion device 10, but other aspect may be adopted. For example, when the amount of treated liquid is increased, the height h at the center of the liquid vessel 12 may be 500 mm or more. In this case, a placement position h′ of the ultrasonic oscillators 14 and 14 is preferably vertically varied to change ultrasound application portions.

The oscillation frequency of the ultrasonic oscillator 14 is preferably 10 to 20 kHz according to the particle crushing capability. The number of ultrasonic oscillators 14 is preferably increased when the amount of treated liquid is increased because the particle crushing capability is reduced. When the number of ultrasonic oscillators 14 is not increased, the reduction in the particle crushing capability can be compensated by increasing a processing time.

The ultrasonic dispersion device 10 according to the present invention is adapted so that the ultrasonic oscillator 14 is secured to the liquid vessel 12 by the ferrule joint 20. The ultrasonic oscillator 14 is extremely easily secured, and thus can be mounted to a liquid vessel 12 having a different capacity according to the amount of treated liquid for ultrasonic dispersion processing. This provides a dispersion device that provides high volume production and also has flexibility.

Next, an operation method of the ultrasonic dispersion device 10 will be described.

A predetermined amount of treated liquid is introduced into the liquid vessel 12. Then, the stirrer 16 is driven at a predetermined RPM to stir the treated liquid. At this time, cooling water controlled at a predetermined temperature is circulated in the cooling jackets 18 and 18 in order to control a temperature of the treated liquid. Then, the ultrasonic oscillator 14 is activated to perform ultrasonic dispersion processing.

Thus, heat at the ultrasonic application portion can be efficiently cooled by stirring the treated liquid. This prevents viscosity reduction of the solvent caused by a temperature increase of the treated liquid to slow down sedimentation velocity of the particles.

In this point of view, the temperature of the treated liquid during the ultrasonic processing is preferably 60° C. or less, and more preferably 45° C. or less. In particular, in batch type ultrasonic processing, intermittent processing is preferable by setting a cooling water temperature or an amount of cooling water, or applying or stopping ultrasound, so as to prevent the temperature of the treated liquid from exceeding 45° C. The treated liquid after the ultrasonic dispersion processing is preferably stored at the liquid temperature of 30° C. or less.

When the device is used for the ultrasonic dispersion processing, greater advantages can be obtained by setting the treated liquid as described below.

Assuming that the fine grained powder in the treated liquid includes spherical monodisperse particles, a relationship between a volume density V and an average particle spacing h (unit: nm) of the particles when dispersed into the treated liquid can be expressed by the following formula (1),
h=dp[(1/(3πV+⅚)^{1/2}−1] formula (1)
where dp is a particle size (unit: nm).

In this case, the volume density of the particles in the treated liquid is preferably set so that a ratio h/dp between the average particle spacing h and the particle size dp is 0.1 to 5 because most of the particles are crushed into a primary particle size by the ultrasonic processing.

Further, the volume density is preferably set so that the ratio h/dp is 0.5 to 1.5 in terms of increase in the particle crushing efficiency by ultrasound application and ensuring dispersion stability of the liquid.

The value of h/dp less than 0.1 is not preferable because particles come into contact with each other to cause reagglomeration to prevent dispersion stability of the liquid even if the volume density of the particles is increased to allow particle crushing by the ultrasound application. On the other hand, when the value of h/dp exceeds 5, the probability that an impact force in destruction of a cavity by the ultrasound application is applied to the particles is reduced as the volume density of the particles is reduced to unpreferably leave uncrushed particles.

When the value of h/dp is set near an upper limit, the reduction in the particle crushing efficiency can be compensated by increasing a processing time in the ultrasonic dispersion processing of the batch type, increasing the stirring RPM of the stirrer 16, or increasing the diameter of the stirring blade 16A.

For the treated liquid, it is preferable that powder only is placed into the solvent for dispersion processing, and then the bonding agent solution is added when the particle crushing proceeds, in terms of increasing absorptive reaction of the bonding agent or the like caused by ultrasonic oscillation, damping of the cavity, or modification of a powder surface after the ultrasonic processing (mechanochemical reaction may occur).

When the treated liquid contains a large amount of resin, the particle crushing does not sufficiently proceed, and thus it is required to set a reduced amount of resin with respect to the powder or set a reduced liquid density.

When the powder only is placed into the solvent of the treated liquid for the dispersion processing, a long processing time causes reagglomeration by excessive dispersion depending on kinds of powder. Thus, when kinds or surface treatment conditions of powder are different, it is preferable to optimize a processing time in view of a liquid density or add a bonding agent solution to ensure dispersion stability as described above.

The embodiment of the ultrasonic dispersion device according to the present invention has been described, but the present invention is not limited to the embodiment, and various aspects may be adopted.

For example, in the embodiment, the two ultrasonic oscillators 14 are provided to face each other, but as described above, the number and the arrangement of the ultrasonic oscillators 14 are not limited to this example. When the height h of the liquid vessel body 12A is large, the plurality of ultrasonic oscillators 14 may be vertically arranged, or when the inner diameter D of the liquid vessel body 12A is large, the plurality of ultrasonic oscillators 14 may be circumferentially arranged.

The shape of the stirrer 16 and the type of the stirring blade 16A are not limited to the example in FIG. 1, and various types of configurations may be used.

1. An ultrasonic dispersion device of a batch type, comprising:
an ultrasonic oscillator; and
a liquid vessel,
wherein an oscillation frequency of the ultrasonic oscillator is 20 kHz or less, the ultrasonic oscillator is secured to the liquid vessel, and the ultrasonic oscillator is able to come into contact with a treated liquid.

2. The ultrasonic dispersion device according to claim 1, wherein the ultrasonic oscillator is secured to the liquid vessel by a one-touch joint.

3. The ultrasonic dispersion device according to claim 1, further comprising a stirring device.

4. The ultrasonic dispersion device according to claim 2, further comprising a stirring device.
